(19) United States
(12) Patent Application Publication
(10) Pub. No.: US 2012/0203144 A1
(43) Pub. Date: Aug. 9, 2012

(54) METHODS AND SYSTEMS FOR TREATING A HOOF ON AN UNGULATE MAMMAL

(75) Inventor: Barbara Anne Collins, San Antonio, TX (US)

(73) Assignee: KCI Licensing, Inc.

(21) Appl. No.: 13/355,259

(22) Filed: Jan. 20, 2012

Related U.S. Application Data
(60) Provisional application No. 61/440,266, filed on Feb. 7, 2011.

(51) Int. Cl. A61H 7/00

(52) U.S. Cl. 601/6

(57) ABSTRACT

Methods and systems of treating a hoof on an ungulate mammal involve delivering reduced pressure to an interior portion of a hoof to promote profusion. In one instance, a method includes forming one or more apertures in a hoof wall of the hoof proximate to laminae that is proximate to a phalanx (P₃) of the hoof, disposing a distribution manifold proximate to the one or more apertures, covering the distribution manifold and a portion of the ungulate mammal's exterior tissue with a sealing member to form a sealed space in which the distribution manifold is disposed, and providing reduced pressure to the distribution manifold in the sealed space. Other methods and systems are also presented.

### RELATED APPLICATION

The present invention claims the benefit, under 35 USC §119(e), of the filing of U.S. Provisional Patent Application Ser. No. 61/440,266, entitled “Methods and Systems for Treating a Hoof on an Ungulate Mammal,” filed 7 Feb. 2011, which is incorporated herein by reference for all purposes.

### FIELD

The present disclosure relates generally to veterinarian treatment methods and systems and, more particularly, but not by way of limitation, to methods and systems for treating a hoof on an ungulate mammal.

### BACKGROUND

At times, animals with hooves (ungulate mammals) may develop medical issues with one or more of their hooves. For example, some ungulate mammals develop laminitis, or founder. Laminitis is an inflammation of the laminae within the hoof. Laminitis may be caused by decreased blood flow to the laminae that leads to ischemia, necrosis, or edema of the laminae. Unless otherwise indicated, as used throughout this document, “or” does not require mutual exclusivity. Laminitis may be devastating to the animal. Various treatments have been used over time, but laminitis remains a significant issue within veterinarian medicine.

### SUMMARY

According to an illustrative embodiment, a method for treating a hoof of an ungulate mammal includes forming one or more apertures in a hoof wall of the hoof proximate to laminae that is proximate to a phalanx (P₃) of the hoof, disposing a distribution manifold proximate to the one or more apertures, covering the distribution manifold and a portion of the ungulate mammal's exterior tissue with a sealing member to form a sealed space in which the distribution manifold is disposed, and providing reduced pressure to the distribution manifold.

According to another illustrative embodiment, a method of treating laminitis on an ungulate mammal's hoof includes exposing tissue proximate to the laminae of the hoof to reduced pressure at or less than (more negative than) −100 mm Hg for greater than eight hours.

According to another illustrative embodiment, a system for treating a hoof of an ungulate mammal includes a distribution manifold for placing proximate to one or more apertures on the hoof proximate to a phalanx (P₃) of the hoof, a sealing member for covering the distribution manifold and a portion of tissue proximate to the one or more apertures to form a sealed spaced in which the distribution manifold is disposed, and a reduced-pressure source fluidly coupled to the sealed space for providing reduced pressure to tissue proximate the phalanx (P₃) of the hoof. The system may also include an attachment device for coupling the reduced-pressure source to the ungulate mammal.

Other features and advantages of the illustrative embodiments will become apparent with reference to the drawings and detailed description that follow.

### BRIEF DESCRIPTION OF THE DRAWINGS

FIG. 1 is a schematic, perspective view of an ungulate mammal on which a system for treating a hoof of the ungulate mammal has been applied;

FIG. 2 is a schematic, cross section (midsagittal section) of a hoof of an ungulate mammal;

FIG. 3 is a schematic, cross section of a hoof of an ungulate mammal with a plurality of apertures formed through a hoof wall;

FIG. 4 is the hoof of FIG. 3 with an illustrative embodiment of a system for treating the hoof with reduced pressure applied;

FIG. 5 is the hoof of FIGS. 3 and 4 after treatment showing the plurality of apertures plugged with filler; and

FIG. 6 is a schematic, cross section of a hoof of an ungulate mammal with another illustrative embodiment of a system for treating the hoof applied.

### DETAILED DESCRIPTION OF ILLUSTRATIVE EMBODIMENTS

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments are defined only by the appended claims.

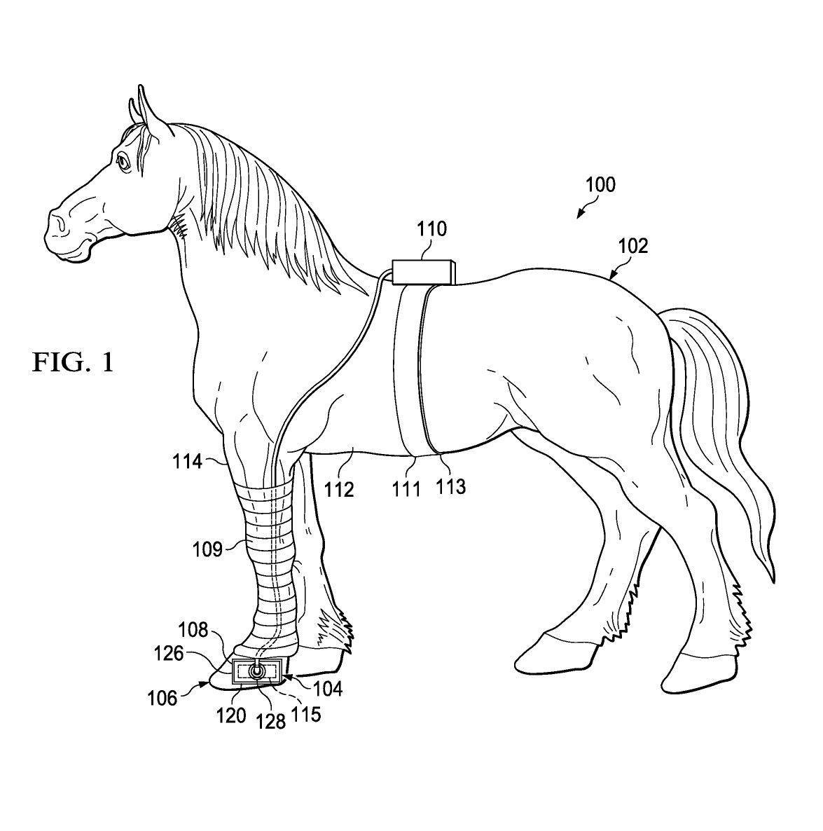

Referring now to the drawings and initially to FIG. 1, an ungulate mammal 100 is shown with an illustrative embodiment of a system 104 for treating a hoof 106 of the ungulate mammal 100 applied. In this illustrative embodiment, the ungulate mammal 100 is a horse 102, but could be any other animal with hooves. The system 104 is for treating laminitis or any other condition on the hoof 106 that may benefit from enhanced profusion or the removal of fluids. The system 104 treats the hoof 106 using reduced pressure.

The system 104 includes a reduced-pressure dressing 108 that is fluidly coupled to or includes a reduced-pressure source 110. In this illustrative embodiment, the reduced-pressure source 110 is a portable reduced-pressure source having a vacuum pump, batteries, and which may have a fluid reservoir for receiving fluids from the hoof 106. The reduced-pressure source 110 is coupled by a reduced-pressure delivery conduit 112 to the reduced-pressure dressing 108. The reduced-pressure source 110 may be releasably coupled by an attachment device 111 to the ungulate mammal 100. For example, the attachment device 111 may be a girth strap 113 or a wrapping (not shown) that holds the reduced-pressure source 110 to the ungulate mammal's leg 114. In another illustrative embodiment, the reduced-pressure source 110 is a micro-pump that is incorporated into the reduced-pressure dressing 108.

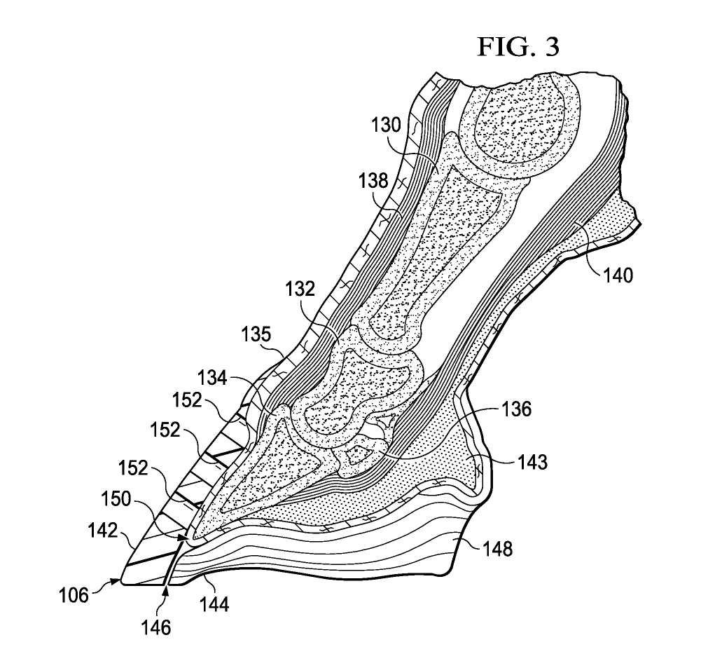

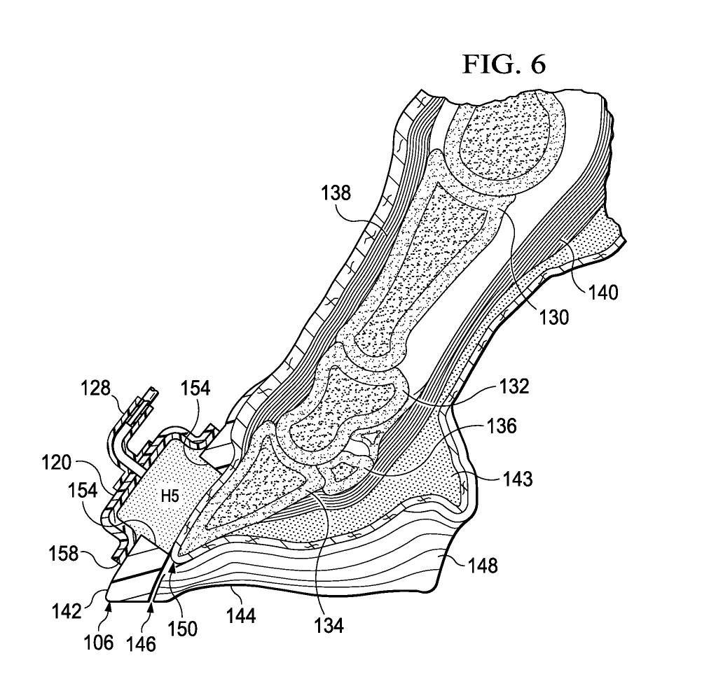

The reduced-pressure dressing 108 may include a distribution manifold 115 (shown in broken lines). The distribution manifold 115 is placed proximate to one or more apertures (see apertures 152 in FIG. 3 and treatment window 154 in FIG. 6) through a hoof wall as described further below. A sealing member 120 covers the distribution manifold 115 and a portion of the ungulate mammal's exterior tissue 126 proximate to the one or more apertures to form a fluid seal and to secure the reduced-pressure dressing 108 to the ungulate mammal 100. A reduced-pressure interface 128 may be applied to the sealing member 120 to fluidly couple the reduced-pressure delivery conduit 112 to the distribution manifold 115.

Reduced pressure generally includes a pressure less than the ambient pressure at a tissue site that is being subjected to treatment. In most cases, this reduced pressure will be less than the atmospheric pressure at which the animal is located. Unless otherwise indicated, values of pressure stated herein are gauge pressures. The reduced pressure delivered may be constant or varied (patterned or random) and may be delivered continuously or intermittently. Although the terms “vacuum” and “negative pressure” may be used to describe the pressure applied to the tissue site, the actual pressure applied to the tissue site may be more than the pressure normally associated with a complete vacuum.

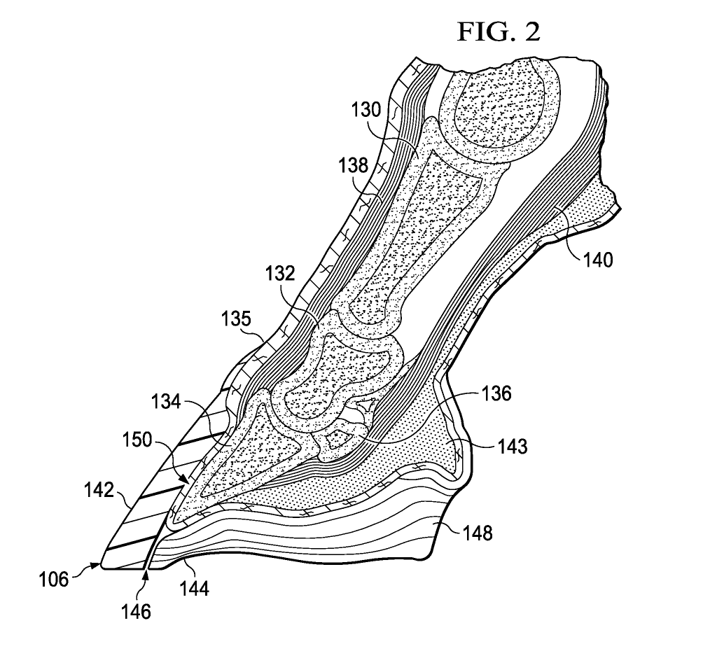

Referring now primarily to FIG. 2, the hoof 106 of FIG. 1 is generally shown in cross section (midsagittal section) before application of the system 104. The series of bones shown include the first phalanx (P₁) 130, second phalanx (P₂) 132, and third phalanx (P₃) or coffin bone 134. A navicular bone 136 is also visible. The main extensor tendon 138 helps extend the coffin bone 134, and the deep digital flexor tendon 140 helps retract the coffin bone 134. The outer portion of the hoof 106 is covered by a hoof wall 142. A coronet 135 is above the hoof wall 142. A sole 144 is under the coffin bone 134. A white line 146 is at an interface between the hoof wall 142 and the sole 144. A digital cushion 143 is on a lower portion of the hoof 106. A portion of an insensitive frog 148 is visible. The insensitive frog 148 is a padded portion of the hoof 106 that comes into contact with the ground.

A laminae 150 is also shown. The laminae is a membrane lining that attaches and suspends the coffin bone 134 within the hoof 106. The laminae 150 have been described as resembling a curtain or drape between the hoof wall 142 and the coffin bone 134. When an ungulate mammal has laminitis, the laminae 150 is the tissue experiencing an issue.

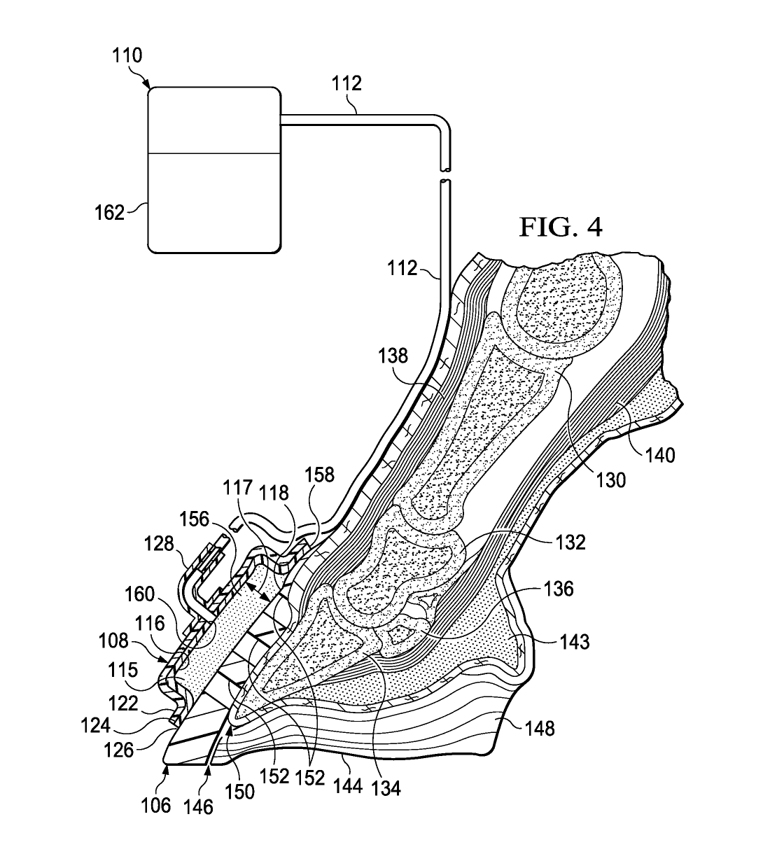

Referring now primarily to FIGS. 3 and 4, and initially to FIG. 3, the hoof 106 of FIGS. 1 and 2 is shown with a plurality of apertures 152 formed through the hoof wall 142. One or more of the apertures 152 are used to provide fluid access to the tissue proximate the laminae 150. The plurality of apertures 152 may be formed by drilling, resecting, or any other technique to remove portions of the hoof wall 142.

As shown in FIG. 4, after one or more apertures 152 are formed in the hoof wall 142, the distribution manifold 115 is disposed proximate to the one or more apertures 152. The distribution manifold 115 has a first side 116 and a second, tissue-facing side 118. While shown over the plurality of apertures 152, when under reduced pressure, the distribution manifold 115 may also enter the plurality of apertures 152.

The distribution manifold 115 is a substance or structure that is provided to assist in applying reduced pressure to, delivering fluids to, or removing fluids from a tissue site. The distribution manifold 115 includes a plurality of flow channels or pathways that distribute fluids provided to and removed from the tissue site around the distribution manifold 115. In one illustrative embodiment, the flow channels or pathways are interconnected to improve distribution of fluids provided to or removed from the tissue site. The distribution manifold 115 comprises one or more of the following: a biocompatible material that is capable of being placed in contact with the tissue site and distributing reduced pressure to the tissue site; devices that have structural elements arranged to form flow channels, such as, for example, cellular foam, open-cell foam, porous tissue collections, liquids, gels, and foams that include, or cure to include, flow channels; porous material, such as foam, gauze, felted mat, or any other material suited to a particular biological application; or porous foam that includes a plurality of interconnected cells or pores that act as flow channels, e.g., a polyurethane, open-cell, reticulated foam such as GranuFoam® material manufactured by Kinetic Concepts, Incorporated of San Antonio, Tex.; a bioresorbable material; or a scaffold material. In some situations, the distribution manifold 115 may also be used to distribute fluids such as medications, antibacterials, growth factors, and various solutions to the tissue site. Other layers may be included in or on the distribution manifold 115, such as absorptive materials, wicking materials, hydrophobic materials, and hydrophilic materials. In one illustrative embodiment, the distribution manifold 115 may have a thickness 117 normal to a surface of the hoof wall 142 of 1 centimeter (cm), 2 cm, 3 cm, 4 cm, 5 cm, or more before reduced pressure in the absence of reduced pressure.

The distribution manifold 115 is covered by the sealing member 120. The sealing member 120 has a first side 122 and a second, tissue-facing side 124. The second, tissue-facing side 124 of the sealing member 120 is disposed proximate to the first side 116 of the distribution manifold 115. The sealing member 120 covers the distribution manifold 115 and the portion 126 of exterior tissue proximate to the plurality of apertures 152 in order to create a fluid seal. Fluid seal is a seal adequate to maintain reduced pressure at a desired site given the particular reduced-pressure source or subsystem involved. The sealing member 120 thus forms a sealed space 156 in which the distribution manifold 115 is disposed.

The sealing member 120 may be any material that provides a fluid seal. The sealing member may be, for example, an impermeable or semi-permeable, elastomeric material. Elastomeric material generally refers to a polymeric material that has rubber-like properties. More specifically, most elastomers have ultimate elongations greater than 100% and a significant amount of resilience. The resilience of a material refers to the material's ability to recover from an elastic deformation. Examples of elastomers may include, but are not limited to, natural rubbers, polyisoprene, styrene butadiene rubber, chloroprene rubber, polybutadiene, nitrile rubber, butyl rubber, ethylene propylene rubber, ethylene propylene diene monomer, chlorosulfonated polyethylene, polysulfide rubber, polyurethane (PU), EVA film, co-polyester, and silicones. Additional, specific examples of sealing member materials include a silicone drape, a 3M Tegaderm® drape, or a polyurethane (PU) drape such as one available from Avery Dennison Corporation of Pasadena, Calif.

The sealing member 120 may be held in place by an attachment device 158. The attachment device 158 may be used to hold the sealing member 120 against the ungulate mammal's hoof wall 142 or another layer, such as a gasket or additional sealing member placed on the hoof 106. The attachment device 158 may take numerous forms. For example, the attachment device 158 may be a medically acceptable, pressure-sensitive adhesive that extends about a periphery or the entire sealing member 120 or any portion of the sealing member 120.

The reduced-pressure interface 128 may be applied to the sealing member 120. The reduced-pressure interface 128 may use an aperture 160 to gain fluid communication with the sealed space 156. The reduced pressure developed by the reduced-pressure source 110 is delivered through the reduced-pressure delivery conduit 112 to the reduced-pressure interface 128 and from the reduced-pressure interface to the sealed space 156 and to the distribution manifold 115. In one illustrative embodiment, the reduced-pressure interface 128 is a T.R.A.C.® Pad or Sensa T.R.A.C.® Pad available from KCI of San Antonio, Tex. The reduced-pressure interfaced 128 may be a conduit placed through the sealing member 120 into the distribution manifold 115.

The reduced-pressure interface 128 is fluidly coupled by the reduced-pressure delivery conduit 112 to the reduced-pressure source 110. The reduced-pressure delivery conduit 112 may be wrapped with a veterinarian wrap 109 to the ungulate mammal's leg 114 as shown in FIG. 1. Non-limiting examples of veterinarian wrap 109 include VETRAP from 3M of St. Paul, Minn. and ELASTIKON from Johnson & Johnson of New Brunswick, N.J. The veterinarian wrap 109 helps secure the reduced-pressure delivery conduit 112 and prevents or inhibits interference from the ungulate mammal 100.

The reduced-pressure source 110 provides reduced pressure for the system 104. The reduced-pressure source 110 may be any device for supplying a reduced pressure, such as a vacuum pump, wall suction, micro-pump, or other source. While the amount and nature of reduced pressure applied to a tissue site will typically vary according to the application, the reduced pressure will typically be between −5 mm Hg (−667 Pa) and −500 mm Hg (−66.7 kPa) and more typically between −75 mm Hg (−9.9 kPa) and −300 mm Hg (−39.9 kPa), and more typically still between −100 mm Hg (−13.3 kPa) and −200 mm Hg (−26.6 kPa).

In an alternative embodiment (not shown), the reduced-pressure source may be a micro-pump, such a piezoelectric pump, incorporated into the reduced-pressure dressing 108. For example, the distribution manifold 115 may be covered on its first side 116 at least partially with an absorbent layer. Proximate to the absorbent layer, one or more cushion layers may be applied and a micro-pump. A battery unit may also be contained with in the reduced-pressure dressing 108 for energizing the micro-pump. The micro-pump exhausts to atmosphere through an aperture in the sealing member 120 and the reduced pressure developed is communicated to the distribution manifold 115. In another related embodiment, the micro-pump may be disposed as a unit exterior to the sealing member 120 and over an aperture 160.

Referring again primarily to FIG. 4, the reduced-pressure source 110 may include a fluid reservoir 162. In other embodiments, a fluid reservoir may be omitted or included as an absorbent layer in the reduced-pressure dressing 108. A hydrophobic filter (not shown) may be used to protect the reduced-pressure source 110 from fluid contamination.

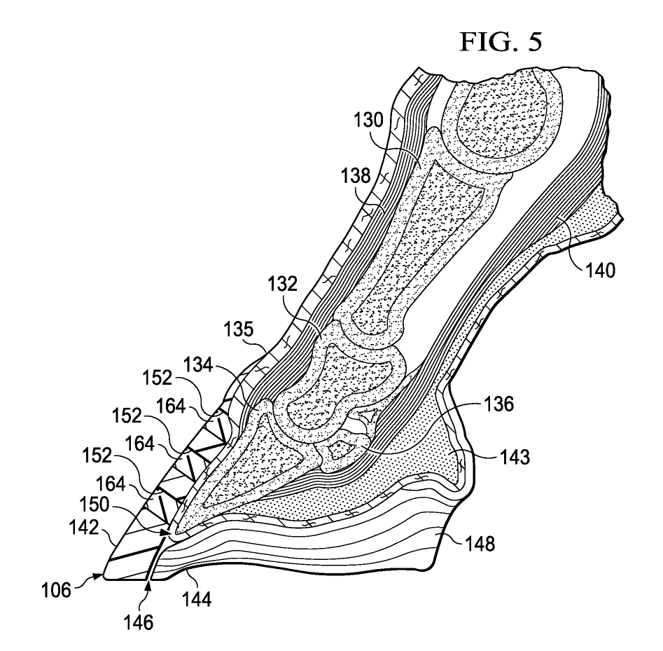

Referring now primarily to FIG. 5, after use, the system 104 may be removed and the one or more apertures 152 may be plugged with a filler 164 or covered with a sealing member or bandage. The filler 164 may be, for example, polyurethane or another polymer, but any material that provides a seal.

Referring now primarily to FIG. 6, the system 104 is shown applied to the hoof 106 utilizing an aperture 152 that is a treatment window 154. The treatment window may have an area greater than 20 cm², 30 cm², 40 cm², 50 cm², or greater. After the treatment window 154 is formed, the distribution manifold 115 is placed proximate to the treatment window 154 such that the distribution manifold 115 is proximate to the laminae or tissue that is proximate to the laminae. Other aspects of the system 104 of FIG. 6 are analogous to the system 104 shown in FIG. 4.

Referring now to FIGS. 1-6, in treating laminitis or another issue with a hoof, the user may first prepare the hoof for application of the system 104 by cleaning, cutting, or filing the hoof as desired. One or more apertures 152 are formed in the hoof wall 142 proximate to the laminae 150, which is proximate to the phalanx (P₃) 134, or proximate to other tissue for which treatment is desired on the hoof 106. Alternatively or in addition, a treatment window 154 may be formed.

The user disposes the distribution manifold 115 proximate to the one or more apertures 152 or the treatment window 154. The distribution manifold 115 and at least a portion of the ungulate mammal's exterior tissue 126 that is proximate to the one or more apertures 152 (or the treatment window 154) are covered with the sealing member 120 to form the sealed space 156. The sealed space 156 contains the distribution manifold 115. If not already applied, the reduced-pressure interface 128 is applied to the sealing member 120. The reduced-pressure delivery conduit 112 is fluidly coupled between the reduced-pressure interface 128 and the reduced-pressure source 110. The attachment device 111, such as the girth strap 113 or a leg wrap, may be applied to the ungulate mammal 100, and the reduced-pressure source 110 may be coupled to or otherwise secured with the attachment device 111. The reduced-pressure source 110 may be secured at any location on the ungulate mammal 100.

The reduced-pressure delivery conduit 112 adjacent to the animal's leg 114 may be wrapped with the veterinarian wrap 109 to hold the reduced-pressure delivery conduit 112 secure and to avoid or minimize interference by the ungulate mammal 100. The reduced-pressure source 110 is activated. The reduced pressure may be supplied constantly or intermittently and may be applied for a few hours, a day, two days, three days, four days, five days, six days, seven days or longer. Other treatment durations may be used as well. The reduced-pressure may be applied at a pressure at or less than (more negative than) −80 mm Hg, e.g., −95 mm Hg; at or less than (more negative than) −100 mm Hg, e.g., −120 mm Hg; at or less than (more negative than) −150 mm Hg, e.g., −175 Hg; or any other reduced pressure that promotes profusion of tissues at or around the laminae.

If an embodiment of the system 104 is used that includes a micro-pump as the reduced-pressure source 110, the application is simplified. After forming the one or more apertures 152 or treatment window 154, the reduced-pressure dressing 108 is applied over the at least one aperture and the micro-pump is activated. The micro-pump develops a reduced pressure in the sealed space 156.

During treatment, other steps may be taken, such as, using a “hoof boot,” e.g., an EASYBOOT from Easycare, Inc. of Tucson, Ariz. The ungulate mammal 100 may also be restricted to prevent the animal from rolling. In parallel or in addition to using the system 104, medications may be given to the mammal to assist with the condition being treated.

After applying reduced pressure for the desired time, the sealing member 120 and distribution manifold 115 are removed. The one or more apertures 152 or treatment window 154 are plugged with a filler.

Although the present invention and its advantages have been disclosed in the context of certain illustrative, non-limiting embodiments, it should be understood that various changes, substitutions, permutations, and alterations can be made without departing from the scope of the invention as defined by the appended claims. It will be appreciated that any feature that is described in connection to any one embodiment may also be applicable to any other embodiment.

1. A method for treating a hoof of an ungulate mammal, the method comprising:
forming one or more apertures in a hoof wall of the hoof proximate to laminae that is proximate to a phalanx (P₃) of the hoof;
disposing a distribution manifold proximate to the one or more apertures;
covering the distribution manifold and a portion of the ungulate mammal's exterior tissue with a sealing member to form a sealed space in which the distribution manifold is disposed; and
providing reduced pressure to the distribution manifold in the sealed space.

2. The method of claim 1, wherein the step of forming one or more apertures comprises drilling a plurality of holes through the hoof wall.

3. The method of claim 1, wherein the step of forming one or more apertures comprises resecting a portion of the hoof wall to form a treatment window.

4. The method of claim 1, wherein the step of forming one or more apertures comprises resecting a portion of the hoof wall to form a treatment window having an area greater than or equal to 30 cm².

5. The method of claim 1, wherein the step of forming one or more apertures comprises resecting a portion of the hoof wall to form a treatment window having an area greater than or equal to 40 cm².

6. The method of claim 1, wherein the step of disposing a distribution manifold comprises disposing a reticulated, polyurethane foam proximate to the one or more apertures.

7. The method of claim 1, wherein the step of disposing a distribution manifold comprises disposing a polyurethane foam proximate to the one or more apertures, and wherein the polyurethane foam has a thickness normal to the hoof wall greater than 2 centimeters in the absence of reduced pressure.

8. The method of claim 1, wherein the step of disposing a distribution manifold comprises disposing a polyurethane foam proximate to the one or more apertures, and wherein the polyurethane foam has a thickness normal to the hoof wall greater than 4 centimeters in the absence of reduced pressure.

9. The method of claim 1, wherein the step of providing reduced pressure to the distribution manifold comprises:
deploying a reduced-pressure interface proximate to the sealing member,
providing a reduced-pressure source, and
fluidly coupling a reduced-pressure delivery conduit between the reduced-pressure source and the reduced-pressure interface.

10. (canceled)

11. (canceled)

12. (canceled)

13. The method of claim 1, wherein:
the step of forming one or more apertures comprises drilling a plurality of holes through the hoof wall;
the step of disposing a distribution manifold comprises disposing a polyurethane foam proximate to the one or more apertures, and wherein the polyurethane foam has a thickness normal to the hoof wall greater than 2 centimeters before reduced pressure is applied; and
the step of providing reduced pressure to the distribution manifold comprises:
deploying a reduced-pressure interface proximate to the sealing member,
providing a reduced-pressure source, and
fluidly coupling a reduced-pressure delivery conduit between the reduced-pressure source and the reduced-pressure interface.

14. The method of claim 1, wherein:
the step of forming one or more apertures comprises resecting a portion of the hoof wall to form a treatment window;
the step of disposing a distribution manifold comprises disposing a polyurethane foam proximate to the one or more apertures, and wherein the polyurethane foam has a thickness normal to the hoof wall greater than 2 centimeters before reduced pressure is applied; and
the step of providing reduced pressure to the distribution manifold comprises:
deploying a reduced-pressure interface proximate to the sealing member,
providing a reduced-pressure source, and
fluidly coupling a reduced-pressure delivery conduit between the reduced-pressure source and the reduced-pressure interface.

15. The method of claim 1, wherein the distribution manifold comprises a foam and an imbedded micro-pump and wherein the step of providing reduced pressure comprises activating the micro-pump.

16. The method of claim 1, further comprising removing the sealing member and distribution manifold and plugging the one or more apertures with a filler.

17. (canceled)

18. A method for treating laminitis on an ungulate mammal's hoof, the method comprising exposing tissue proximate to the laminae of the hoof to reduced pressure at or less than (more negative than) −100 mm Hg for greater than eight hours.

19. The method of claim 18, wherein the step of exposing tissue proximate to the laminae of the hoof to reduced pressure comprises exposing the tissue proximate to the laminae of the hoof to reduced pressure for at least five days.

20. The method of claim 18, wherein the step of exposing tissue proximate to the laminae of the hoof to reduced pressure comprises exposing the tissue proximate to the laminae of the hoof to reduced pressure at or less than (more negative than) −150 mm Hg.

21. A system for treating a hoof of an ungulate mammal, the system comprising:
a distribution manifold positioned proximate to one or more apertures formed on the hoof proximate to a phalanx (P₃) of the hoof;
a sealing member covering the distribution manifold and a portion of tissue proximate to the one or more apertures to form a sealed spaced in which the distribution manifold is disposed; and
a reduced-pressure source fluidly coupled to the sealed space for providing reduced pressure to tissue proximate the phalanx (P₃) of the hoof.

22. The system of claim 21, further comprising an attachment device coupled to the reduced-pressure source for releasably securing the reduced-pressure source to the ungulate mammal.

23. The system of claim 21, wherein the distribution manifold comprises a reticulated, polyurethane foam.

24. The system of claim 21, wherein the distribution manifold comprises a reticulated, polyurethane foam and wherein the polyurethane foam has a thickness normal to the hoof wall greater than 2 centimeters in the absence of reduced pressure.

25. The system of claim 21, wherein the distribution manifold comprises a reticulated, polyurethane foam and wherein the polyurethane foam has a thickness normal to the hoof wall greater than 4 centimeters in the absence of reduced pressure.

26. The system of claim 21, further comprising a girth strap coupled to the reduced-pressure source.

27. The system of claim 21, wherein the distribution manifold comprises a foam and an imbedded micro-pump.
